(19) United States
(12) Patent Application Publication
(10) Pub. No.: US 2015/0076256 A1
(43) Pub. Date: Mar. 19, 2015

(54) HIGH PRESSURE ELETROHYDRAULIC VALVE ACTUATOR

(71) Applicant: INTERNATIONAL ENGINE INTELLECTUAL PROPERTY COMPANY , LLC, LISLE, IL (US)

(72) Inventor: Oswald Baasch, Bowling Green, KY (US)

(21) Appl. No.: 14/027,347

(22) Filed: Sep. 16, 2013

(51) Int. Cl. F02M 63/00

(52) U.S. Cl. CPC F02M 63/004; F02M 63/0059
USPC 239/584; 251/30.01

(57) ABSTRACT

A system and method for operating a valve for an engine utilizing a high pressure actuating fluid that is used in the operation of fuel injectors. A pump may be used to increase the pressure of the actuating fluid, such as, for example, to 4000 psi. At least a portion of this high pressure actuating fluid may be delivered to a fuel injector. Additionally, at least a portion of the pressure actuating fluid may be delivered to an electro-hydraulic actuator. According to certain embodiments, the flow of the high pressure actuating fluid to the actuator may be controlled by spool valve. The spool valve may be part of the actuator. The use of the high pressure actuating fluid to operate the actuators may allow for a reduction in the actuators' size, which may allow for the actuator to be located in the valve.

### BACKGROUND

The illustrated embodiments relate to the use of high pressure actuating fluid from a high pressure hydraulic system to drive actuators that perform valve actuation. Further, certain embodiments relate to the use of a high pressure hydraulic system that drive ancillaries on an engine, such as, for example, pressure amplified diesel injector systems, to also drive actuators that perform valve actuation.

An engine control unit (ECU) or other electric controllers are often used to control various aspects of the operation of an engine and/or vehicle. During engine operation, the ECU may provide instructions or data that is used to actuate actuators that are operably attached or coupled to one or more valves. The adjustment of a valve's position may be used to control a variety of different engine operations, including, for example, the rate or amount of fuel that is supplied through a fuel injector to a combustion chamber, the air-to-fuel ratio, ignition timing, and idle speed, among other operations.

The type of actuator(s) used to control engine and/or vehicle operations may vary. For example, the types of actuators employed for valve actuation includes electric, pneumatic/electro-pneumatic, and electro-hydraulic actuators. Electric actuators may perform valve actuation through the use of stepper motors, permanent magnet direct current (PMDC) motors, and brushless direct current (BLDC) motors. However, the reliability of electric valve actuation may be hindered by the harsh operating environments that may be present in the engine compartment or other areas of the vehicle, including elevated engine temperatures, temperature fluctuations, high vibration and exposure to potentially corrosive environmental elements. Pneumatic/electro-pneumatic valve actuation may use compressed air to control linear or rotary actuators. However, pneumatic/electro-pneumatic valve actuation may suffer from low positional accuracy due to the compressible nature of the fluids being used, such as air, and the moisture generated in an associated air compression system.

Electro-hydraulic valve activation uses linear and rotary actuators. Electro-hydraulic actuators typically use oil from the engine's lubricating system to operate the actuators. Therefore, during normal engine operation, the pressure of the lubricating oil that is used to operate electro-hydraulic actuators may fluctuate from approximately 30 to 100 psi. Moreover, the pressure of the lubricating oil typically varies with engine speed. Additionally, as lubricating oil is used by the engine's lubrication system, the lubricating oil supplied to operate the actuator is relatively hot. The properties of the oil change with temperature, which affects the performance of the actuator. As the pressure of the lubricating oil used to operate the actuator is relatively low, actuators typically need to be relatively large in size in order to achieve the output forces or torque needed to operate the actuator and/or the associated valve. However, increasing the size of the actuator may result in the actuator having a relatively large inertia and packaging constraints. Additionally, relatively large quantities of this low pressure lubricating oil flow needs to flow through the actuator so as to move the large actuator with force sufficient to move the actuator in a manner that allows the actuator to have the requisite power to change the position of the associated valve. Yet, the need to use relatively large quantities of lubricating oil flowing through the actuator may result in the actuator being relatively slow when moving from a rest to a start position, and when stopping the movement of the actuator.

### BRIEF SUMMARY

An aspect of the illustrated embodiment is a system for operating a valve for an engine. The system includes a pump that is configured to increase the pressure of an actuating fluid to approximately 2500 to 6000 psi to provide a high pressure actuating fluid. The system also includes a supply line that is configured to deliver at least a portion of the high pressure actuating fluid to a spool valve. According to certain embodiments, the spool valve may have at least one outlet port. The system also includes at least one actuator. The actuator includes at least one chamber that is configured to receive the high pressure actuating fluid from the at least one outlet port of the spool valve. Additionally, the at least one actuator is configured to change the position of a valve when the high pressure actuating fluid is delivered to at least one of the at least one chambers.

Another aspect of the illustrated embodiment is a system for operating a valve for an engine. The system includes a pump that is configured to increase the pressure of an actuating fluid. A first supply line is configured to deliver at least a portion of the pressurized actuating fluid to a fuel injector. Additionally, a second supply line is configured to deliver at least a portion of the pressurized actuating fluid to a spool valve. The spool valve is configured to move from a closed position and at least one open position. At least one actuator is configured to receive the pressurized actuating fluid delivered to the spool valve when the spool valve is in an open position. The system also includes a valve that is operably attached to the at least one actuator. The valve is configured to be moved between a first position and a second position by the at least one actuator.

Another aspect of the illustrated embodiment is a method for operating a valve. The method includes pressurizing an actuating fluid to provide a pressurized actuating fluid. At least a portion of the pressurized actuating fluid is delivered to a fuel injector. Additionally, at least a portion of the pressurized actuating fluid is delivered to a spool valve. The spool valve may be moved to an open position. The method further includes delivering the pressurized actuating fluid through the opened spool valve to an actuator. The actuator may be operated by the flow of the pressurized actuating fluid into the actuator. Further, the operation of the actuator may move the position of a valve that is operably attached to the actuator.

### BRIEF DESCRIPTION OF SEVERAL VIEWS OF THE DRAWINGS

FIG. 1 illustrates a cross-sectional view of a representative hydraulically actuated, electronically controlled fuel injector.

FIG. 2 illustrates a schematic of a system using a high pressure actuating fluid to operate electro-hydraulic actuators.

FIG. 3 illustrates a cross-sectional view of a rack and pinion actuator.

FIG. 4 illustrates a perspective side view of a rotary actuator.

### DETAILED DESCRIPTION

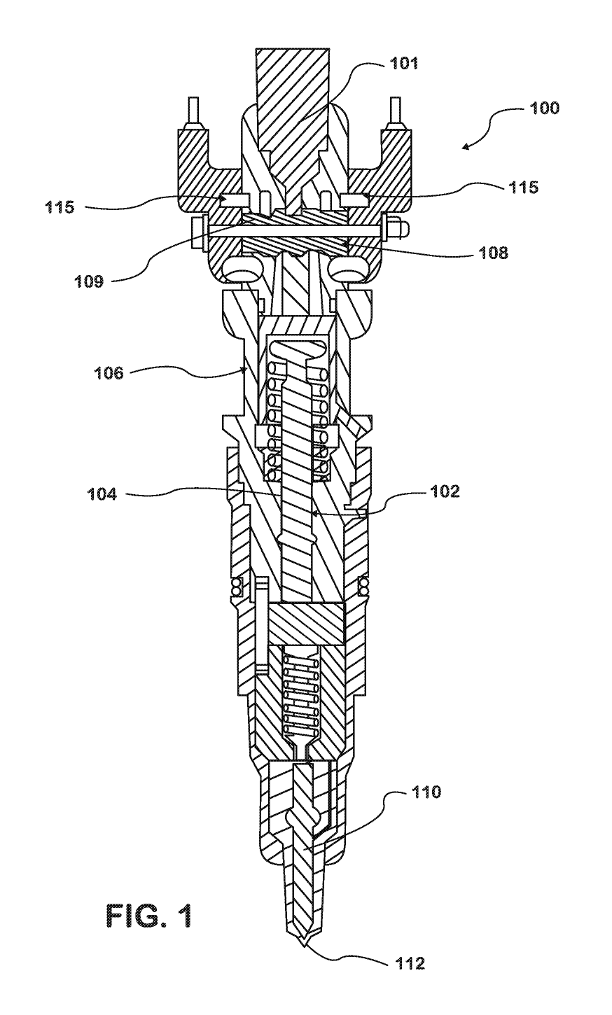

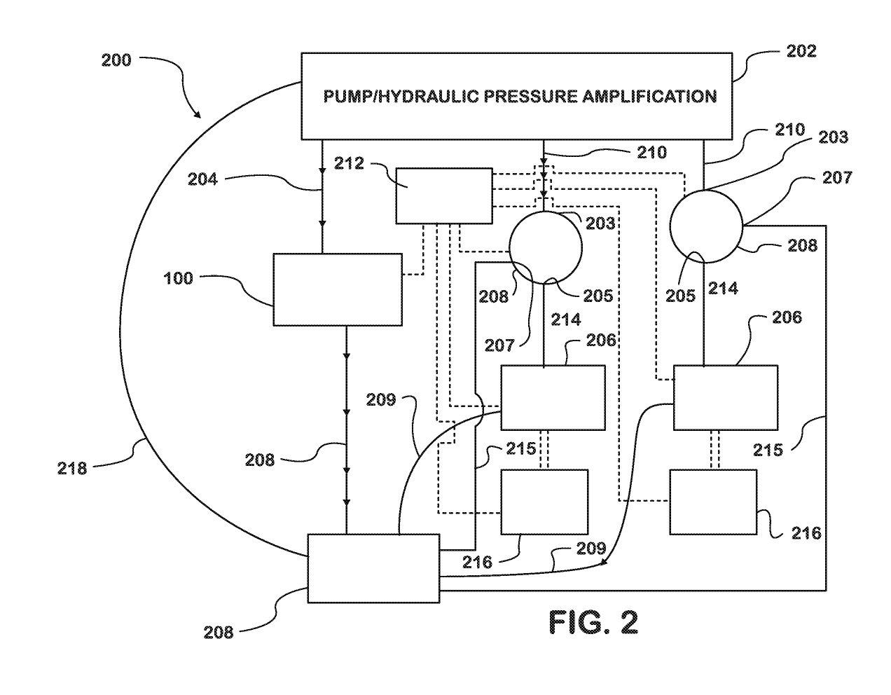

Referencing FIGS. 1 and 2, fuel injectors 100 may be used with a hydraulically actuated, electronically controlled, unit fuel injection system (HEUI). In an HEUI fuel system, an actuating fluid, such as oil, is supplied at high pressure through a hose, tube, or common rail 204 to each of a series of unit fuel injectors 100 within the cylinder head. Prior to delivery, the pressure of the actuating fluid may be increased by a high-pressure fluid pump and/or a hydraulic amplification system 202. This high-pressure fluid pump may be driven by a variety of sources, such as, for example being an engine power-take off component or driven electrically. According to certain embodiments, the hydraulic amplification system 202 may be used to elevate the pressure of the actuating fluid to approximately 2500 to 6000 psi. However, the pressures obtained by the amplification system may be dependent on the type and/or size of the pump used by the amplification system 202. Fluid from the rail 202 may be delivered to the fuel injector 100 through a fluid inlet 101 in the fuel injector 100.

Referencing FIG. 1, each injector 100 includes an electronically controlled control valve 108 that governs the application of the high pressure actuating fluid to provide a force used by the injector 100 to inject fuel into the engine cylinder. Moreover, the control valve 108 may be used to control the timing and amount of the actuating fluid flowing into the injector 100 through a fluid inlet 101.

The actuating fluid control valve 108 may at least assist in initiating, and the termination of, the fuel injection process. For example, the control valve 108 may be a spool valve that is controlled by the ECU 212. According to certain embodiments, the ECU 212 may control the application of an electric current being delivered across one or more coils 115 that causes a cylinder 109 of the spool valve to move, such as, for example, slide, between first and second positions. By moving the cylinder 109 to the second position, an actuating fluid pathway that was previously closed or blocked by the cylinder 109 may be opened. Actuating fluid may then be able to flow through the pathway to a location adjacent to a top portion of a plunger 102. The plunger 102 may be positioned within an internal pumping chamber 104 of an intensifier piston 106 of the fuel injector 100. Accumulated actuating fluid may provide a force that downwardly displaces the plunger 102, which amplifies the fuel pressure in the pumping chamber 104 to a magnitude large enough to force a normally closed valve 110, such as a needle valve, at an outlet 112 of the fuel injector 100 to open. When the latter valve 110 opens, the amplified fuel pressure forces fuel through the outlet 112 and into the combustion chamber of the engine.

The injection of fuel from the fuel injector 100 may be terminated by terminating a control signal to the electronically control valve 108. When that happens, the valve 110 at the outlet 112 of the fuel injector 100 may return to a normally closed condition, and fuel flows from the rail to refill the pumping chamber, forcing the plunger 102 to retract in the process. The actuating fluid in the fuel injector 100 that was used to displace the plunger 102 may then be exhausted from the fuel injector 100, and at least a portion of the actuating fluid may eventually be collected in a sump 208, as shown in FIG. 2. Further, the cylinder 109 Of the spool valve may return to a first position in which the cylinder 109 closes or blocks the actuating fluid pathway.

Besides being used in the operation of a fuel injector 100, the high pressure actuating fluid may be used in operating one or more actuators 206. For example, for illustration purposes, FIG. 2 provides a schematic of a system 200 using high pressure actuating fluid to operate one or more electro-hydraulic actuators 206. Such a system 200 may replace the use of low pressure lubricating oil with the relatively substantially higher pressurized actuating fluid. While FIG. 2 illustrates the use of the hydraulic amplification system 202 that is also used for fuel injectors 100, according to other embodiments, the system 200 may have a dedicated pump that is used to drive the actuators 206, and is not used for pressurizing fuel for the fuel injectors 100. Such an embodiment may be particularly suited for engines such as diesel engines that use common rail direct injection systems, were the diesel injection pressure is not amplified by hydraulic system but is pressurized by a high pressure diesel fuel pump.

As shown, the system 200 includes the high pressure pump or hydraulic amplification system 202 that is used to increase the pressure of the actuating fluid. At least a portion of the actuating fluid may be delivered to one or more fuel injectors 100 through the common rail 204, as previously discussed. At least a portion of the high pressure actuator fluid is also supplied to a spool valve 208 that is used operate an actuator 206 in a manner similar to the spool valve used to operate the injector 100. According to certain embodiments, the spool valve 208 may be a traditional hydraulic spool valve 208 that has one or more ports to direct the high pressure actuating fluid into and out of the spool valve 208, as discussed below in more detail.

For illustrative purposes, the spool valve 208 shown in FIG. 2 is a three-way port valve, in which the spool valve 208 has an inlet port 203, an outlet port 205, and a discharge port 207. The inlet port 203 of the spool valve 208 receives high pressure actuation fluid from the hydraulic amplification system 202 through a supply line or hose 210. When the actuator 206 is to be activated, the high pressure actuating fluid may exit the spool valve 208 through the outlet port 205 of the spool valve 208, wherein the high pressure actuating fluid is delivered to a chamber of the actuator 206, such as a first chamber, through an actuating fluid supply line 214. When the outlet port 205 is closed, the discharge port 207 of the spool valve 208 may be opened, thereby allowing high pressure actuating fluid delivered to the spool valve 208 to be delivered to a sump 208 via a return line 215. When the outlet port 205 is closed and high pressure actuating fluid is not being supplied to the actuator 206, the actuator may return to a first position by a spring. However, according to other embodiments in which the spool valve 208 has more than one outlet port 205, such as when the actuator is a four-way valve, a second outlet port may be used to deliver high pressure actuating fluid to a second chamber of the actuator 206 while high pressure actuating fluid is evacuated from the first chamber of the actuator 206. In such embodiments, the delivery of high pressure actuating fluid to the second chamber may cause the actuator 206 to move in a direction opposite to that of when the high pressure actuating fluid was delivered to the first chamber of the actuator 206.

Actuating fluid may be delivered through one or more inlet tubes or hoses 210 to an inlet port 203 of the spool valve 208. The operation of the spool valve 208 may be controlled by the ECU 212, which may employ electronic hardware used to operate the spool valve 208 that are the same or similar to the electronic hardware used to operate the control valve 108 of the fuel injector 100. The ECU 212 may deliver a signal or electric current that is used to move a cylinder within the spool valve 208 between a closed position and one or more open positions or positions therebetween. Similar to the control valve of the injector 108, the cylinder of the spool valve 208 may be moved through the application of electrical current that draws or repels the cylinder of the spool valve 208 to/away from different valve positions.

The position of the spool valve 208 may influence which direction the actuator 206 moves the attached valve 216, and thereby change the position of the valve 216, including for example, moving the valve 216 between open and closed positions, a vice versa, as well as positions there between. For example, each of the open positions of the spool valve 208 may be in communication with a different inlet ports and chambers in the actuator 206. According to certain embodiments, if the spool valve 208 is in a first open position, actuating fluid may flow through a first outlet port 205 in the spool valve 208, through an actuator supply line 214, and enter an inlet of a first chamber of a rotary actuator. The high pressure actuating fluid may then flow through the first chamber from the first chamber inlet to the first chamber outlet. This flow path may cause a shaft of the rotary actuator 206 that drives a valve 216 to move in either a clockwise or counterclockwise direction. Conversely, in this example, if the spool valve 208 has second outlet port, when the first outlet port 205 of the spool valve 208 is closed and the second outlet port is open, actuating fluid may flow out of the second outlet and be delivered to the inlet of a second chamber of the actuator 206. The actuating fluid may then flow in a direction in the second chamber that causes the shaft of the actuator 206 to move in a direction opposite of that which the shaft was moving when the high pressure actuating fluid was being supplied to the first chamber. Further, while actuating fluid is being supplied to the second chamber of the actuator 206, actuating fluid may be being exhausted from the first chamber of the actuator 206.

Unlike electro-hydraulic linear or rotary actuators typically used in vehicles, the actuators 206 in the illustrated embodiment are driven by high pressure actuating fluid, such as, for example, actuating fluid that has a pressure of around 4000 psi. By delivering such high pressure actuating fluid to the actuator 206, the electro-hydraulic actuators 206 may have miniaturized components in comparison to similar actuators that operate by the lower pressure engine lubricating oil. For example, if the valve 216 that is being operated by a rack and pinion actuator requires that actuator 206 achieve a continuous torque of 5 N-m, the use of lubricating oil at a typical pressure of 100 psi would require the use of a 25 mm pinion traveling 25 mm, which would require a volumetric displacement of lubricating oil of approximately 12,272 mm³ through the actuator. However, if the same 5 N-m torque were provided by a rack and pinion actuator 206 driven by the high pressure actuating fluid described as herein, a 4000 psi actuating fluid could obtain the same 5 N-m through using a 9 mm diameter piston traveling only 5 mm, which would use a volumetric displacement actuating fluid of approximately 318 mm³ through the actuator 206. Thus, the use of the high pressure actuating fluid may allow the size of the rack and pinion electrohydraulic actuator 206 to be significantly reduced. Additionally, the use of a substantially smaller amount of fluid to drive the actuator 206 (in the prior example approximately 318 mm³ versus approximately 12,272 mm³) also allows for faster response times when an actuator 206 is to start moving after being in a rest condition and when movement of the actuator 206 is to stop. Additionally, a balance may be arrived between the size of the pump 202 needed for the actuating fluid to have the high pressure, and the fact that the pump 202 needs to displace a substantially smaller quantity of actuating fluid to operate the actuators 206.

Further, by being able to reduce the size of the actuator 206 in the present system, the electro-hydraulic actuator 206 may also be positioned at locations that are not typically permissible for actuators that are operated with low pressure lubricating oil. For example, the miniature sizes for the rack and pinion electro-hydraulic actuator 206 that may be obtained by the present system 200 may be designed as an integral part of the housing for the valve 216 that is being operated by the actuator 206, including, for example, being contained in the valve 216. Thus, while the spool valve 208 illustrated in FIG. 2 is shown as being separate from the actuator 206, according to other embodiments, the spool valve 208 may be attached to or part of the actuator 206.

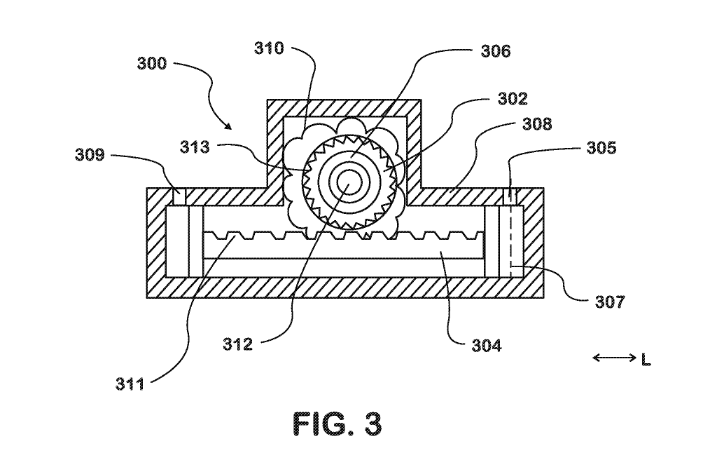

A variety of different types of hydro-electric actuators 206 may be used by the present system 200, such as linear and rotary actuators. For example, for illustrative purposes, FIG. 3 demonstrates a cross-sectional view of a rack and pinion actuator 300 that may be used with the illustrated system 200. As shown, the rack and pinion actuator 300 includes a pinion 302, a rack 304, and a casing 308. High pressure actuating fluid may enter into the casing 308 through a first inlet port 305 and flow along a chamber 307 of the casing 308 before flowing out of the casing 308 through a first outlet port 309. The chamber 307 is typically separate from the rack 304 and the pinion 302 so that high pressure actuating fluid does not flow in contact from the rack 304 and the pinion 302 as the actuating fluid flows through the chamber 307. The flow of the high pressure actuating fluid may be used to move or push the rack 304. As the rack 304 moves, teeth 311 in the rack 304 may engage serrations or teeth 313 in the pinion 302, and thereby cause the pinion 302 to rotate in a clockwise direction. The rotation of the pinion 302 may drive a shaft 312 that is connected or coupled to the pinion 302 and the valve 216 and that transmits the torque to at least assist in changing the position of the valve 216.

In addition, or in lieu of utilizing multiple spool valve 208 outlet ports 205, the rack and pinion actuator 300 and the spool valve 208 may be further minimized in size and/or complexity through the use of a spring return approach. According to such an embodiment, the rack and pinion actuator 300 may include a first inlet port 305 and a first outlet port 309 that use the hydraulic pressure from the actuating fluid flowing through the first inlet port 305 to drive the shaft 312 in one direction. When actuating fluid is no longer supplied to the chamber, a compression spring may be used to drive the shaft 312 of the rack and pinion actuator 300 in the opposite direction. According to such certain embodiments, at times during operation, the actuating fluid may be supplied to the rack and pinion actuator 300 at a rate sufficient to prevent movement of the shaft 312 by either the hydraulic pressure of the actuating fluid or pressure from the compression spring.

Given the relatively small sizes attainable for the pinion 302 and rack 304 for the actuator 300 in the illustrate system 200, the shaft 312 may also be used as a position sensor component. The sensor component may be used to provide the ECU 212 with data or information indicating, or to be used to determine, the position of the actuator 206, 300 and/or the valve 216. For example, according to certain embodiments, the pinion 302 may include, or have attached thereto, an annular permanent magnet 306, while the housing or casing 308 of the actuator 206 includes a coil 310. According to such an embodiment, the movement of the magnet may be detected by one or more magneto resistive Hall Effect sensors. However, the actuator 206 and/or valve 216 may include a variety of other, different ways to sense the position of the actuator 206, 300 and/or the valve 216. For example, the position of the valve 216 can be sensed using non-contact rotational sensor that senses the movement of the pinion 302 or the shaft 312 that is attached or coupled to the pinion 302.

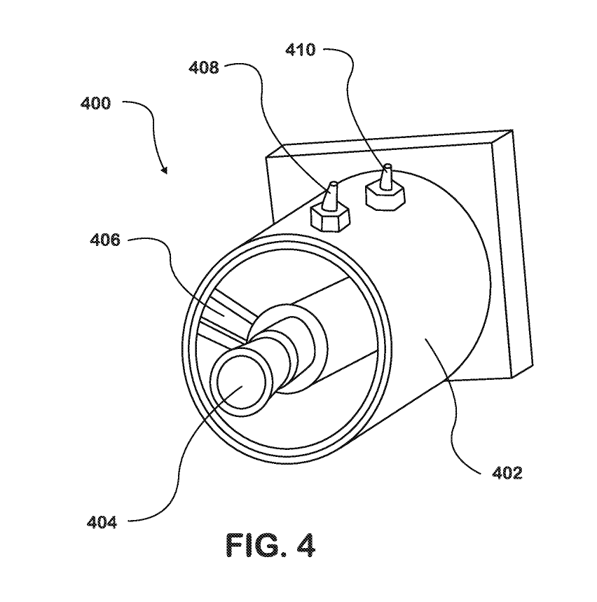

FIG. 4 illustrates a perspective side view of a typical rotary actuator 400 having a housing 402, a shaft 404, at least one vane 406, a first port 408, and a second port 410. As with such rotary actuators 400, the supply of high pressure actuating fluid through the first and second ports 408, 410 to the housing 402 causes the vane 406 and attached shaft 404 to move in a circular direction about the housing 402. The direction of the movement of the shaft 404 may be determined by which inlet port 408 is supplied with actuating fluid from the spool valve 208. Accordingly, the rotary actuator 400 may be configured to move the vane 406, and thus the shaft 404, in a clockwise direction when the high pressure actuating fluid is supplied to housing through the first or second port 408, 410 and in a counter-clockwise direction when the actuating fluid is supplied to the other of the first or second port 408, 410. Further, as the high pressure actuating fluid is being supplied from the spool valve 208 to one of the first and second ports 408, 410, a separate exhaust port may be used to evacuate high pressure fluid that was already in housing 402 so that pressure from the incoming high pressure actuating fluid may move the vane 406.

The rotary actuator valve 400 and associated spool valve 208 may be simplified by the addition of a torsional spring. More specifically, according to certain embodiments, the spool valve 208 may be simplified so that high pressure actuating fluid is delivered to one port 408. High pressure actuating fluid may enter into the housing 402 to move the shaft 404 in a first direction. When the shaft 404 is to be moved in the second, opposite direction, the high pressure actuating fluid that entered into the housing 402 through the port 408 may at least be partially evacuated from the housing 402, such as through a separate exhaust port in the actuator 400, thereby allowing the force associated with the torsional spring to move the shaft in the second direction.

Referring back to FIG. 2, as high pressure actuating fluid exits the actuator 206, such as, for example, through the outlet port 309, the high pressure actuating fluid may be delivered to the sump 208 through an outlet tube 209. Actuating fluid that accumulates in the sump 208 may then be delivered to the pump or hydraulic pressure amplification system 202 by a return hose or tube 218 to be recirculated in the system 200 for use again by the fuel injectors 100 or the actuators 206 as a high pressure actuating fluid.

1. A system for operating a valve for an engine comprising:
a pump configured to increase the pressure of an actuating fluid to approximately 2500 to 6000 psi to provide a high pressure actuating fluid;
a supply line configured to deliver at least a portion of the high pressure actuating fluid to a spool valve, the spool valve having at least outlet port; and
at least one actuator, the at least actuator having at least one chamber configured to receive the high pressure actuating fluid from the at least one outlet port of the spool valve, the at least one actuator configured to change the position of a valve when high pressure actuator fluid is delivered to at least one of the at least one chamber.

2. The system of claim 1, wherein the spool valve is integrated into the at least one actuator.

3. The system of claim 2, wherein the at least one actuator is positioned in a housing of the valve.

4. The system of claim 1, wherein the system further includes a sump, the sump configured to receive at least a portion of the actuating fluid that is released from the at least one actuator.

5. The system of claim 1, wherein the at least one actuator is an electro-hydraulic actuator.

6. The system of claim 1, wherein the electro-hydraulic actuator is a rack and pinion actuator, the rack and pinion actuator including a pinion and a casing, the pinion having a annular permanent magnet, the casing having a coil, wherein the annular permanent magnet and the coil are used in sensing the position of the valve.

7. A system for operating a valve for an engine comprising:
a pump configured to increase the pressure of an actuating fluid;
a first supply line configured to deliver at least a portion of the pressurized actuating fluid to a fuel injector;
a second supply line configured to deliver at least a portion of the pressurized actuating fluid to a spool valve, the spool valve being configured to be moved between a closed position and at least one open position;
at least one actuator configured to receive the pressurized actuating fluid delivered to the spool valve when the spool valve is in one of the at least one open positions; and
a valve operably attached to the at least one actuator, the valve configured to be moved between a first position and a second position by the at least one actuator.

8. The system of claim 7, wherein the spool valve is positioned within the at least one actuator.

9. The system of claim 8, wherein the at least one actuator is positioned in a housing of the valve.

10. The system of claim 9, wherein the at least one actuator is an electro-hydraulic actuator.

11. The system of claim 7, wherein the system further includes a sump configured to receive at least a portion of the actuating fluid released from the at least one actuator.

12. The system of claim 7, wherein the pump is configured to pressurize the actuating fluid to approximately 2500 to 6000 psi.

13. The system of claim 7, wherein the at least one actuator is a rack and pinion actuator that includes an inlet port, an outlet port, and a compression spring, the rack and pinion actuator configured for the pinion to move in a first direction when pressurized actuating fluid flows through a chamber in the rack and pinion actuator from the inlet port to the outlet port, the compression spring configured to move the pinion in a second direction that is opposite to the first direction when the pressurized actuating fluid is exhausted from the chamber

14. The system of claim 7, wherein the at least one actuator is a rotary actuator that includes a port, a torsional spring, a housing, a vane, and a shaft, the shaft being operably attached to the vane, the port configured to receive pressurized actuating fluid from the spool valve and direct the a pressurized actuating fluid into the housing to rotate the vane in a first direction, the torsional spring configured to rotate the vane in a second direction that is opposite to the first direction.

15. A method for operating a valve comprising:
pressurizing an actuating fluid to provide a pressurized actuating fluid;
delivering at least a portion of the pressurized actuating fluid to a fuel injector;
delivering at least a portion of the pressurized actuating fluid to a spool valve;
moving the spool valve to an open position;
delivering the pressurized actuating fluid through the opened spool valve to an actuator;
operating the actuator by the flow of the pressurized actuating fluid through the actuator; and
moving the position of a valve that is operably attached to the actuator by the operation of the actuator.
